(19) United States
(12) Patent Application Publication
(10) Pub. No.: US 2024/0168362 A1
(43) Pub. Date: May 23, 2024

(54) LENS DRIVING APPARATUS AND CAMERA MODULE INCLUDING THE SAME

(71) Applicant: SAMSUNG ELECTRO-MECHANICS CO., LTD., Suwon-si (KR)

(72) Inventors: Sungho KANG, Suwon-si (KR); Kum-Kyung LEE, Suwon-si (KR)

(73) Assignee: SAMSUNG ELECTRO-MECHANICS CO., LTD., Suwon-si (KR)

(21) Appl. No.: 18/491,114

(22) Filed: Oct. 20, 2023

(30) Foreign Application Priority Data
Nov. 22, 2022 (KR) 10-2022-0157077

(51) Int. Cl. G03B 5/02; G03B 3/10; G03B 17/12

(52) U.S. Cl. CPC G03B 5/02; G03B 3/10; G03B 17/12; G03B 2205/0015; G03B 2205/0069

(57) ABSTRACT

A lens driving apparatus includes a lens holder having a central opening so as to accommodate a lens, a carrier configured to accommodate the lens holder, an optical image stabilization (OIS) driving magnet holder having an OIS driving magnet mounted thereon, supported by the carrier, coupled to the lens holder, and configured to be driven in a direction perpendicular to an optical axis, and an OIS driving coil facing the OIS driving magnet at an interval, in a direction perpendicular to the optical axis and to a direction in which the OIS driving magnet is driven.

### CROSS-REFERENCE TO RELATED APPLICATIONS

This application claims the benefit under 35 USC 119(a) of Korean Patent Application No. 10-2022-0157077 filed on Nov. 22, 2022, in the Korean Intellectual Property Office, the entire disclosure of which is incorporated herein by reference for all purposes.

### BACKGROUND

### 1. Field

The present disclosure relates to a lens driving apparatus and a camera module including the same.

### 2. Description of the Background

Advancing information communication and semiconductor technologies accelerate the spread and use of electronic devices. The electronic devices tend to converge and provide various functions while moving outside their traditional unique areas.

In recent years, cameras have been generally adopted in portable electronic devices such as tablet personal computers, laptop computers and the like, as well as in smartphones, and an auto focus (AF) function, an optical image stabilization (OIS) function, a zoom function, and the like have been added to the cameras provided in the portable electronic devices.

The auto focus function is a function of enabling a clear image to be obtained on an imaging surface of an image sensor by moving a lens positioned in front of the image sensor along an optical axis direction, depending on a distance from a photographic subject.

The optical image stabilization function may include a camera shaking correction, a hand trembling correction, and the like, and may prevent an image of a photographic subject to be captured from vibrating due to camera shaking or hand trembling by a photographer in a state in which the camera is moving or fixed.

In a magnet-coil structure for optical image stabilization, there may be a problem that efficiency of a driving magnetic field part may not be maximized due to a change in air gap between a magnet and a coil resulting from OIS driving.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens driving apparatus includes a lens holder having a central opening so as to accommodate a lens, a carrier configured to accommodate the lens holder, an optical image stabilization (OIS) driving magnet holder having an OIS driving magnet mounted thereon, supported by the carrier, coupled to the lens holder, and configured to be driven in a direction perpendicular to an optical axis, and an OIS driving coil facing the OIS driving magnet at an interval, in a direction perpendicular to the optical axis and to a direction in which the OIS driving magnet is driven.

The lens driving apparatus may further include an auto focus (AF) driving part including an AF driving magnet mounted on the carrier and an AF driving coil positioned to face the AF driving magnet, and configured to drive the lens holder in the optical axis direction.

The OIS driving magnet holder may include a first OIS driving magnet holder extending in a first direction perpendicular to the optical axis direction and a second OIS driving magnet holder extending in a second direction perpendicular to the optical axis direction and the first direction.

The lens holder may include a coupling groove extending in one direction, and the OIS driving magnet holder may include a coupling arm inserted in the coupling groove.

The coupling groove may extend from one outer surface of the lens holder toward the central opening.

The coupling groove may be formed on an upper surface of the lens holder with respect to the optical axis direction.

The coupling arm may extend in a direction perpendicular to one outer surface of the lens holder.

A rolling member may be arranged between the coupling arm and a bottom surface of the coupling groove.

The coupling arm may be arranged biased to one side relative to a longitudinal center of the OIS driving magnet holder.

The OIS driving magnet holder may include a coupling groove extending in one direction, and the lens holder may include a coupling arm inserted in the coupling groove.

The coupling groove may extend toward the central opening perpendicularly to one outer surface of the lens holder.

The coupling arm may extend in an outward direction perpendicularly to one outer surface of the lens holder.

The carrier may include a mounting support portion positioned outside one outer surface of the lens holder, and the OIS driving magnet holder may be mounted in the mounting support portion of the carrier.

The OIS driving magnet holder may further include a magnet accommodation portion extending in a direction parallel to the one outer surface of the lens holder, mounted in the mounting support portion, and configured to accommodate the OIS driving magnet, and a rolling portion extending in a direction parallel to the one outer surface of the lens holder from the magnet accommodation portion.

The rolling portion of the OIS driving magnet holder and the mounting support portion may each include a guide recess, and a rolling member may be arranged between the guide recess of the rolling portion and the guide recess of the mounting support portion.

A valley of the guide recess of the rolling portion and a valley of the guide recess of the mounting support portion may be arranged to face each other in an oblique direction with respect to the optical axis direction.

The mounting support portion may further include at least one of a side surface OIS yoke facing the OIS driving magnet in a direction perpendicular to the optical axis direction, and a lower surface OIS yoke facing the OIS driving magnet in a direction parallel to the optical axis direction.

The lens holder and the carrier may each have at least four corner areas facing each other in the optical axis direction, rolling parts with rolling members interposed in at least three corner areas among the four corner areas may be positioned between the lens holder and the carrier, the carrier may include a support area comprising the rolling parts in three corner areas, among the rolling parts, in which the rolling members contact and support the lens holder and the carrier.

The OIS driving magnet holder may be arranged at an edge of the carrier corresponding to the support area.

In the support area, the carrier may further include at least one of a side surface OIS yoke facing the OIS driving magnet in a direction perpendicular to the optical axis direction, and a lower surface OIS yoke facing the OIS driving magnet in a direction parallel to the optical axis direction.

An interval between the OIS driving magnet and the OIS driving coil may be configured to be maintained uniformly when the OIS driving magnet holder is driven.

A portable electronic device may include a camera module having the lens driving apparatus, a lens barrel including the lens disposed in the central opening of the lens holder, an image sensor configured to convert light incident through the lens barrel into an electrical signal, and a housing configured to accommodate the lens barrel and the lens driving apparatus.

In another general aspect, a camera module includes a lens barrel including a lens, a lens holder having a central opening in which the lens barrel is accommodated, a carrier configured to accommodate the lens holder, an OIS driving magnet holder having an optical image stabilization (OIS) driving magnet mounted thereon, supported by the carrier, coupled to the lens holder, and configured to be driven in a direction perpendicular to an optical axis, and a housing configured to accommodate the carrier and including an OIS driving coil facing the OIS driving magnet at an interval, in a direction perpendicular to the optical axis and to a direction in which the OIS driving magnet is driven.

The camera module may further include an auto focus (AF) driving part including an AF driving magnet mounted on the carrier and an AF driving coil positioned to face the AF driving magnet, and configured to drive the lens holder in the optical axis direction.

The OIS driving magnet holder may include a first OIS driving magnet holder extending in a first direction perpendicular to the optical axis direction and a second OIS driving magnet holder extending in a second direction perpendicular to the optical axis direction and the first direction.

The lens holder may include a coupling groove extending in one direction, and the OIS driving magnet holder may include a coupling arm inserted in the coupling groove.

The OIS driving magnet holder may include a coupling groove extending in one direction, and the lens holder may include a coupling arm inserted in the coupling groove.

The carrier may include a mounting support portion positioned outside one outer surface of the lens holder, and the OIS driving magnet holder may be arranged in the mounting support portion of the carrier.

The mounting support portion may further include at least one of a side surface OIS yoke facing the OIS driving magnet in a direction perpendicular to the optical axis direction, and a lower surface OIS yoke facing the OIS driving magnet in a direction parallel to the optical axis direction.

The lens holder and the carrier may each have at least four corner areas facing each other in the optical axis direction, rolling parts with rolling members interposed in at least three corner areas among the four corner areas may be positioned between the lens holder and the carrier, the carrier may include a support area comprising the rolling parts in three corner areas, among the rolling parts, in which the rolling members contact and support the lens holder and the carrier.

The OIS driving magnet holder may be arranged at an edge of the carrier corresponding to the support area.

In the support area, the carrier may further include at least one of a side surface OIS yoke facing the OIS driving magnet in a direction perpendicular to the optical axis direction, and a lower surface OIS yoke facing the OIS driving magnet in a direction parallel to the optical axis direction.

A portable electronic device may include the camera module, and an image sensor configured to convert light incident through the lens barrel into an electrical signal, wherein the image sensor is disposed below the housing of the camera module.

In another general aspect, a lens driving apparatus includes a lens holder having a central opening to accommodate a lens, a carrier configured to accommodate the lens holder, and an optical image stabilization (OIS) driver configured to drive the lens holder in a first direction perpendicular to the optical axis, wherein the OIS driver includes an OIS driving magnet disposed on the carrier and spaced apart from an OIS driving coil in a second direction perpendicular to the optical axis by a gap, and wherein the gap is maintained uniformly when the lens holder is driven in the first direction.

The OIS driving magnet may be disposed in an OIS driving magnet holder supported by the carrier, coupled to the lens holder, and slide-driven in a third direction relative to the carrier by interaction between the OIS driving magnet and the OIS driving coil.

The second direction may be the same as or different than the first direction, the third direction may be the same as or different than the first direction, and the third direction may be perpendicular to the second direction.

The lens holder may include a coupling groove extending in one direction, and the OIS driving magnet holder may include a coupling arm inserted in the coupling groove.

The OIS driver may further include a second OIS driving magnet disposed on the carrier and spaced apart from a second OIS driving coil in a third direction perpendicular to the second direction by a second gap, and the second gap may be maintained uniformly when the lens holder is driven in the first direction.

The lens driving apparatus may further include an auto focus (AF) driving magnet disposed on the carrier and configured to be driven in the optical axis direction.

A portable electronic device may include a camera module including the lens driving apparatus, a lens barrel including the lens disposed in the central opening of the lens holder, an image sensor configured to convert light incident through the lens barrel into an electrical signal, and a housing configured to accommodate the lens barrel and the lens driving apparatus.

Other features and aspects will be apparent from the following detailed description, the drawings, and the claims.

### BRIEF DESCRIPTION OF THE DRAWINGS

FIG. 1 is a perspective view showing an appearance of a camera module according to an embodiment.

FIG. 2 is an exploded perspective view schematically showing an example of the camera module shown in FIG. 1.

FIG. 3 is a perspective view showing an example of a lens driving apparatus of the camera module shown in FIG. 1.

FIG. 4 is an exploded perspective view of an example of the lens driving apparatus shown in FIG. 3.

FIG. 5 is a partial cross-sectional view taken along a line V-V′ of FIG. 3.

FIG. 6 is a partial cross-sectional view taken along a line VI-VI′ of FIG. 3.

FIG. 7 is a plan view of an example of the lens driving apparatus shown in FIG. 3, showing a carrier and a support frame together with an OIS driving magnet holder.

FIG. 8 is a plan view of an example of the lens driving apparatus shown in FIG. 3, showing the carrier, the support frame, and a lens holder together with the OIS driving magnet holder.

FIG. 9 is a plan view showing an example of the lens driving apparatus of the camera module shown in FIG. 1.

FIG. 10 is a plan view showing an example of an operation state of the lens driving apparatus of the camera module shown in FIG. 1.

FIG. 11 is an exploded perspective view schematically showing a camera module according to another embodiment.

FIG. 12 is a perspective view showing a lens driving apparatus of a camera module according to still another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Further, as disclosed herein, when it is referred to as “on a plane”, it means when a target part is viewed from above, and when it is referred to as “on a cross-section”, it means when the cross-section obtained by cutting a target part vertically is viewed from the side.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The described technology has been made in an effort to provide a lens driving apparatus capable of maintaining a uniform interval between a driving magnet and a driving coil while performing an optical image stabilization function.

The described technology has also been made in an effort to provide a camera module in which efficiency of a driving magnetic field part is improved by maintaining a uniform interval between a driving magnet and a driving coil for optical image stabilization.

However, the problems to be solved by the embodiments are not limited to the above problems, and may be variously extended within a range of the technical idea included in the present disclosure.

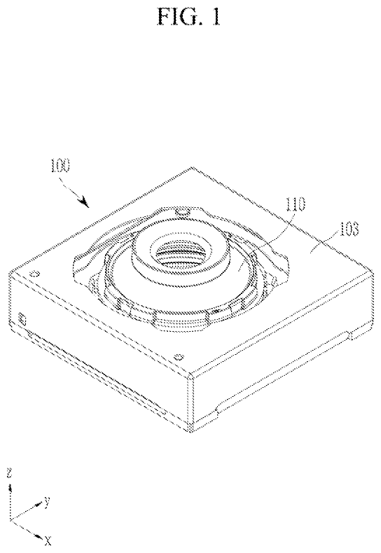

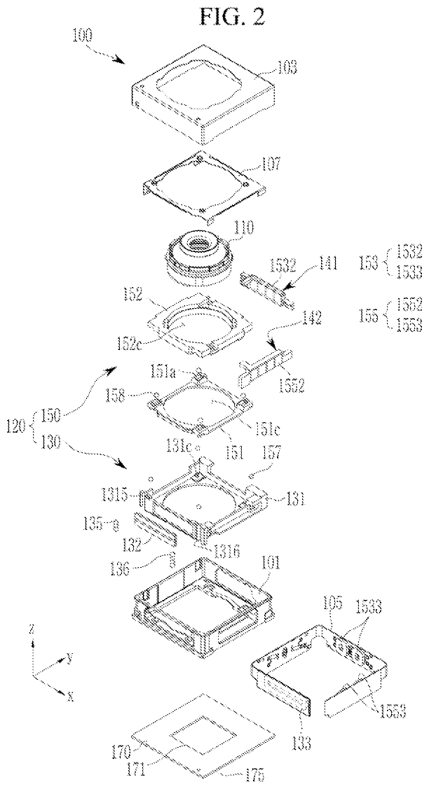

FIG. 1 is a perspective view showing an appearance of a camera module according to an embodiment, and FIG. 2 is an exploded perspective view schematically showing an example of the camera module shown in FIG. 1.

Referring to FIGS. 1 and 2, a camera module 100 according to the present embodiment includes a lens barrel 110, a lens driving apparatus 120 configured to move the lens barrel 110, an image sensor unit 170 configured to convert light incident through the lens barrel 110 into an electrical signal, a housing 101 configured to accommodate the lens barrel 110 and the lens driving apparatus 120, and a cover 103 configured to cover the housing 101.

The lens barrel 110 may have a hollow cylindrical shape so that one or more lenses for capturing an image of a photographic subject may be accommodated therein, and the one or more lenses may be mounted in the lens barrel 110 along an optical axis. The one or more lenses may be arranged as many as necessary according to a predetermined design of the lens barrel 110, and each lens may have the same or different optical characteristics, such as a refractive index.

The optical axis may be set as a central axis of the one or more lenses accommodated in the lens barrel 110, and an optical axis direction refers to a direction parallel to the central axis. In the drawings, the optical axis is set as the z-axis, and the x-axis and y-axis are set as directions perpendicular to the optical axis. The x-axis and the y-axis are perpendicular to each other, and the x-y plane formed by the x-axis and the y-axis becomes a plane perpendicular to the optical axis.

The lens driving apparatus 120 is an apparatus configured to move the lens barrel 110, and may include an auto focus (AF) unit 130 configured to adjust a focus and an optical image stabilization (OIS) unit 150 configured to correct hand trembling or shaking.

For example, the lens driving apparatus 120 may be configured to adjust a focus by moving the lens barrel 110 in the optical axis direction (z-axis direction in the drawings) by using the AF unit 130, and to correct shaking during image capturing by moving the lens barrel 110 in a direction (x-axis or y-axis direction in the drawings) perpendicular to the optical axis direction by using the OIS unit 150.

The AF unit 130 may include a carrier 131 configured to accommodate the lens barrel 110, and an AF driving part configured to generate a driving force for moving the lens barrel 110 and the carrier 131 in the optical axis direction. The AF driving part may include an AF driving magnet 132 and an AF driving coil 133.

When power is applied to the AF driving coil 133, the carrier 131 can be moved in the optical axis direction by an electromagnetic influence between the AF driving magnet 132 and the AF driving coil 133. Since the lens barrel 110 is accommodated in the carrier 131, the focus can be adjusted while the lens barrel 110 is also moved in the optical axis direction by the movement of the carrier 131.

For example, the AF driving magnet 132 may be mounted on one surface of the carrier 131, and the AF driving coil 133 may be mounted on the housing 101 via a board 105. Here, the AF driving magnet 132 is a movement member mounted on the carrier 131 and configured to move in the optical axis direction together with the carrier 131, and the AF driving coil 133 is a fixed member fixed on the housing 101. However, the present disclosure is not limited thereto, and the AF driving magnet 132 and the AF driving coil 133 may also be arranged with positions thereof being exchanged with each other.

Rolling members 135 and 136 may be arranged between the carrier 131 and the housing 101 so as to reduce friction between the carrier 131 and the housing 101 when the carrier 131 is moved. The rolling members 135 and 136 may each have a ball shape and may be arranged on both sides relative to a center of one side of the carrier 131. The rolling members 135 and 136 arranged on both sides as such may each have different numbers of balls, and for example, may include three balls on a left side and four balls on a right side. The carrier 131 may be formed with guide recesses 1315 and 1316 so that the rolling members 135 and 136 can be accommodated and guided in the optical axis direction.

The OIS unit 150 may be used to correct blurring of an image or shaking of a video due to factors such as trembling of a user's hand when capturing an image or a video. That is, when shaking occurs during image capturing due to trembling of a user's hand or the like, the OIS unit 150 is configured to compensate for the shaking by applying relative displacement corresponding to the shaking to the lens barrel 110. As an example, the OIS unit 150 may correct the shaking by moving the lens barrel 110 in first and second directions (x-axis and y-axis directions) perpendicular to the optical axis direction.

The OIS unit 150 may include a guide member configured to guide movement of the lens barrel 110, and an OIS driving part configured to generate a driving force for moving the guide member in a direction perpendicular to the optical axis direction.

The guide member may include a support frame 151 and a lens holder 152. The support frame 151 and the lens holder 152 may be accommodated in the carrier 131 and aligned along the optical axis direction, and serve to guide movement of the lens barrel 110. The support frame 151 and the lens holder 152 have central openings 151c and 152c into which the lens barrel 110 may be inserted, respectively, and the lens barrel 110 may be joined and fixed to the lens holder 152 through the central opening 152c. As an example, the lens holder 152 may have a frame shape having four corners, and the support frame 151 may also have a frame structure having four corners corresponding thereto.

The OIS driving part may include a first OIS driving part 153 and a second OIS driving part 155. The first OIS driving part 153 may be configured to generate a driving force in the first direction (x-axis direction in the drawings) perpendicular to the optical axis, and the second OIS driving part 155 may be configured to generate a driving force in the second direction (y-axis direction in the drawings) perpendicular to the first direction. The first and second OIS driving parts 153 and 155 may include OIS driving magnets 1532 and 1552, and OIS driving coils 1533 and 1553, respectively.

The carrier 131 may have edges surrounding a periphery of the lens holder 152, in which OIS driving magnet holders 141 and 142 for OIS driving may be slidably mounted on some of the edges. The OIS driving magnet holders 141 and 142 may include the OIS driving magnets 1532 and 1552, and may be coupled to the lens holder 152 and slide-driven together. For example, when the carrier 131 has four edges, the OIS driving magnet holders 141 and 142 may be each arranged on each of two edges of the carrier 131 adjacent to each other.

The OIS driving magnets 1532 and 1552 may be mounted on the OIS driving magnet holders 141 and 142, and the OIS driving coils 1533 and 1553 facing the OIS driving magnets 1532 and 1552, respectively, may be fixedly mounted on the housing 101 via the board 105. As another example, a structure is also possible in which the OIS driving coils are mounted on the OIS driving magnet holders and the OIS driving magnets are fixedly mounted on the housing, which also falls within the scope of the present disclosure.

Meanwhile, a plurality of rolling members for supporting the OIS unit 150 may be provided. The plurality of rolling members may serve to smooth movements of the support frame 151 and the lens holder 152 during an OIS driving process. In addition, the plurality of rolling members may also serve to maintain intervals among the carrier 131, the support frame 151 and the lens holder 152.

The plurality of rolling members may include a first rolling member 157 and a second rolling member 158. The first rolling member 157 may be involved in movement of the OIS unit 150 in the first direction (x-axis direction), and the second rolling member 158 may be involved in movement of the OIS unit 150 in the second direction (y-axis direction). The first rolling member 157 may include a plurality of ball members arranged between the carrier 131 and the support frame 151, and the second rolling member 158 may include a plurality of ball members arranged between the support frame 151 and the lens holder 152.

A surface of the carrier 131 facing the support frame 151 in the optical axis direction may be formed with a first guide recess portion 131c configured to accommodate the first rolling member 157. The first guide recess portion 131c may include a plurality of guide recesses. The first rolling member 157 may be accommodated in the first guide recess portion 131c and may be sandwiched between the carrier 131 and the support frame 151. In a state of being accommodated in the first guide recess portion 131c, the first rolling member 157 may be limited in movement in the optical axis direction and the second direction (y-axis direction), and may be moved in the first direction (x-axis direction).

A surface of the support frame 151 facing the lens holder 152 in the optical axis direction may be formed with a second guide recess portion 151a configured to accommodate the second rolling member 158. The second guide recess portion 151a may include a plurality of guide recesses. The second rolling member 158 may be accommodated in the second guide recess portion 151a and may be sandwiched between the support frame 151 and the lens holder 152. In a state of being accommodated in the second guide recess portion 151a, the second rolling member 158 may be limited in movement in the optical axis direction and the first direction (x-axis direction), and may be moved in the second direction (y-axis direction). To this end, a planar shape of each of the plurality of guide recesses of the second guide recess portion 151a may be a rectangle whose length in the second direction may be greater than a width in the first direction.

The image sensor unit 170 may be an apparatus configured to convert light incident through the lens barrel 110 into an electrical signal. As an example, the image sensor unit 170 may include an image sensor 171 and a printed circuit board 175 connected thereto, and may further include an infrared filter. The infrared filter serves to block light in an infrared region of light incident through the lens barrel 110.

The lens barrel 110 and the lens driving apparatus 120 may be accommodated in an internal space of the housing 101. As an example, the housing 101 may have a box shape in which upper and lower portions are open. The image sensor unit 170 may be arranged below the housing 101. A stopper 107 may be further arranged above the lens barrel 110 so as to prevent separation of the support frame 151 and the lens holder 152 from the internal space of the carrier 131. The stopper 107 may be joined to the carrier 131.

The cover 103 may be joined to the housing 101 to surround an external surface of the housing 101, and may serve to protect internal components of the camera module 100. In addition, the cover 103 may serve to shield electromagnetic waves. As an example, the cover 103 may be formed of a metal shield can to shield electromagnetic waves so that the electromagnetic waves generated by the camera module 100 do not affect other electronic components in a portable electronic device.

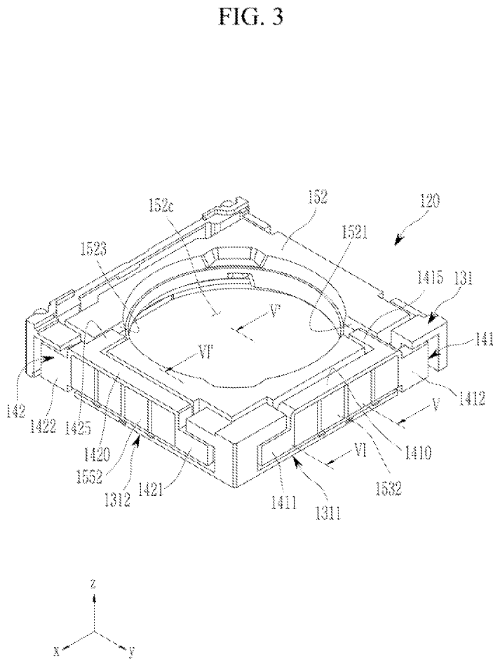

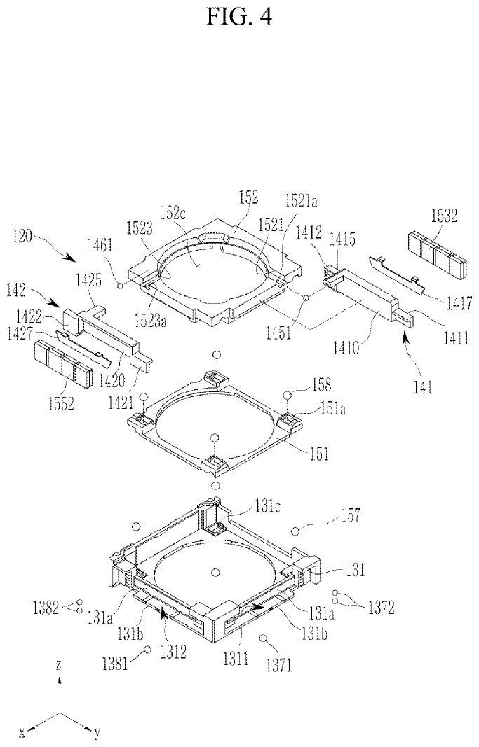

FIG. 3 is a perspective view showing an example of the lens driving apparatus of the camera module shown in FIG. 1, and FIG. 4 is an exploded perspective view showing an example of the lens driving apparatus shown in FIG. 3.

Referring to FIGS. 3 and 4, in the lens driving apparatus 120 according to the present embodiment, the OIS driving part configured to move the support frame 151 and the lens holder 152 in directions perpendicular to the optical axis direction may include the first OIS driving part 153 and the second OIS driving part 155.

The first OIS driving part 153 may include the first OIS driving magnet 1532 and the first OIS driving coil 1533, and the first OIS driving magnet 1532 may be mounted on the first OIS driving magnet holder 141. In addition, the second OIS driving part 155 may include the second OIS driving magnet 1552 and the second OIS driving coil 1553, and the second OIS driving magnet 1552 may be mounted on the second OIS driving magnet holder 142.

In the present embodiment, the first OIS driving coil 1533 and the second OIS driving coil 1553 may be mounted on the board 105 as described with reference to FIG. 2, and the board 105 may be fixedly arranged along edge portions of the housing 101. After the lens driving apparatus 120 is assembled, the first and second OIS driving coils 1533 and 1553 may be arranged to face the first and second OIS driving magnets 1532 and 1552 mounted on the first and second OIS driving magnet holders 141 and 142 in a direction perpendicular to the optical axis. In this case, the direction in which the first OIS driving magnet 1532 and the first OIS driving coil 1533 face each other may be perpendicular to the direction in which the second OIS driving magnet 1552 and the second OIS driving coil 1553 face each other.

The first and second OIS driving magnet holders 141 and 142 may be coupled to the lens holder 152 to drive movements of the lens holder 152 in the first direction (x-axis direction in the drawings) and the second direction (y-axis direction in the drawings), respectively. The first and second OIS driving magnet holders 141 and 142 may be arranged at adjacent different edges of the carrier 131 and slide-driven. The carrier 131 may include mounting support portions 1311 and 1312 at edges, and the first and second OIS driving magnet holders 141 and 142 may be mounted in the mounting support portions 1311 and 1312, respectively.

Specifically, the carrier 131 may include the mounting support portions 1311 and 1312 at two edges orthogonal to each other, the first OIS driving magnet holder 141 may be arranged in the mounting support portion 1311 and extend in the first direction, and the second OIS driving magnet holder 142 may be arranged in the mounting support portion 1312 and extend in the second direction. For spaces in which the first and second OIS driving magnet holders 141 and 142 are positioned in the mounting support portions 1311 and 1312, some clearance may be secured so that at least the OIS driving magnet holders 141 and 142 can move in the extension directions thereof, respectively.

The lens holder 152 may include coupling grooves 1521 and 1523 extending from an outer surface toward the central opening 152c, and the OIS driving magnet holders 141 and 142 may include coupling arms 1415 and 1425 extending in a direction perpendicular to the outer surface of the lens holder 152, respectively. The coupling arms 1415 and 1425 of the OIS driving magnet holders 141 and 142 may be inserted into the coupling grooves 1521 and 1523 of the lens holder 152, whereby the OIS driving magnet holders 141 and 142 can be coupled to the lens holder 152. That is, when the OIS driving magnet holders 141 and 142 are driven in the first or second direction perpendicular to the optical axis, the coupled lens holder 152 can be driven in the first or second direction together with the OIS driving magnet holders.

The coupling grooves 1521 and 1523 may be formed on an upper surface of the lens holder 152 with respect to the optical axis direction. Also, the coupling grooves 1521 and 1523 may be formed to penetrate from the outer surface of the lens holder 152 to the central opening 152c. The coupling grooves 1521 and 1523 may include a first coupling groove 1521 and a second coupling groove 1523 extending in directions perpendicular to each other. In this case, the first coupling groove 1521 may extend in a direction perpendicular to one outer surface of the lens holder 152, and the second coupling groove 1523 may extend in a direction perpendicular to another outer surface of the lens holder 152 and face toward the central opening 152c. As another example, the coupling groove may be formed on a lower surface of the lens holder 152 with respect to the optical axis direction, and may be formed so as not to penetrate from the outer surface of the lens holder 152 to the central opening 152c, which also falls within the scope of the present disclosure.

Rolling members 1451 and 1461 may be arranged between the coupling arms 1415 and 1425 of the OIS driving magnet holders 141 and 142 and the coupling grooves 1521 and 1523 of the lens holder 152. The rolling members 1451 and 1461 may each have a ball shape. Guide recesses 1521a and 1523a are formed on bottom surfaces of the coupling grooves 1521 and 1523 so that the rolling members 1451 and 1461 are partially accommodated and movable ranges thereof can be thus limited.

The OIS driving magnet holders 141 and 142 may extend along edges of the carrier 131, in which the coupling arms 1415 and 1425 may be arranged biased to one side relative to longitudinal centers of the OIS driving magnet holders 141 and 142. Therefore, the coupling grooves 1521 and 1523 formed so that the coupling arms 1415 and 1425 of the OIS driving magnet holders 141 and 142 are inserted therein may also be each arranged biased to one side relative to a center of one outer surface of the lens holder 152.

The coupling arms 1415 and 1425 include a first coupling arm 1415 formed on the first OIS driving magnet holder 141 and a second coupling arm 1425 formed on the second OIS driving magnet holder 142. Accordingly, the first coupling arm 1415 may be inserted into the first coupling groove 1521, and the second coupling arm 1425 may be inserted into the second coupling groove 1523.

The OIS driving magnet holders 141 and 142 may include magnet accommodation portions 1410 and 1420, and rolling portions 1411, 1412, 1421, and 1422 extending from the magnet accommodation portions 1410 and 1420. The magnet accommodation portions 1410 and 1420 each extend in a direction parallel to one outer surface of the lens holder 152, and may be mounted in the mounting support portions 1311 and 1312 to accommodate the OIS driving magnets 1532 and 1552. The OIS driving magnets 1532 and 1552 may be mounted in the magnet accommodation portions 1410 and 1420 with metal yokes 1417 and 1427 interposed therebetween, whereby the OIS driving magnets 1532 and 1552 can be fixed to the OIS driving magnet holders 141 and 142 more firmly.

The rolling portions 1411, 1412, 1421, and 1422 integrally extending from the magnet accommodation portions 1410 and 1420 may extend parallel to one outer surface of the lens holder 152. The rolling portions 1411, 1412, 1421, and 1422 may include front end rolling portions 1411 and 1421 and rear end rolling portions 1412 and 1422 arranged at both ends of the magnet accommodation portions 1410 and 1420 in a longitudinal direction of the OIS driving magnet holders 141 and 142. The rear end rolling portions 1412 and 1422 may be positioned closer to the coupling arms 1415 and 1425 than the front end rolling portions 1411 and 1421.

Rolling members 1371, 1372, 1381, and 1382 may be interposed between the rolling portions 1411, 1412, 1421, and 1422 of the OIS driving magnet holders 141 and 142 and the mounting support portions 1311 and 1312 of the carrier 131 so that the OIS driving magnet holders 141 and 142 can be smoothly slide-driven. The rolling portions 1411, 1412, 1421, and 1422 of the OIS driving magnet holders 141 and 142 and the mounting support portions 1311 and 1312 may include guide recesses on surfaces facing each other, respectively, and the rolling members 1371, 1372, 1381, and 1382 may be arranged between the guide recesses of the rolling portions 1411, 1412, 1421, and 1422 and the guide recesses of the mounting support portions 1311 and 1312, and movable ranges thereof can be thus limited. The rolling members 1371, 1372, 1381, and 1382 may each have a ball shape, and the rolling members 1371, 1372, 1381, and 1382 that are arranged corresponding to the front end rolling portions 1411 and 1421 and the rear end rolling portions 1412 and 1422 may be arranged differently in numbers thereof. As an example, one ball may be arranged on each of the front end rolling portions 1411 and 1421, and two balls may be arranged on each of the rear end rolling portions 1412 and 1422. However, the present disclosure is not limited thereto.

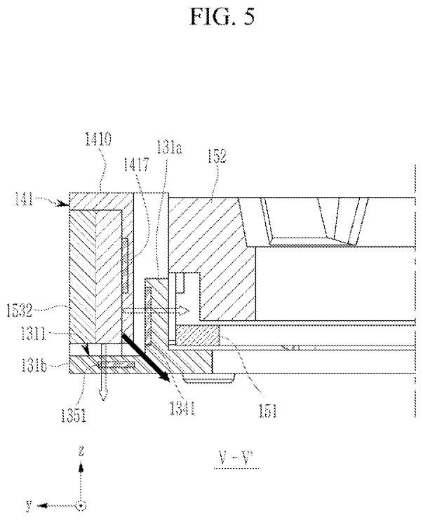

FIG. 5 is a partial cross-sectional view taken along a line V-V′ of FIG. 3.

In the lens driving apparatus 120 according to the present embodiment, a side surface OIS yoke 1341 and a lower surface OIS yoke 1351 may be arranged in the mounting support portions 1311 and 1312 of the carrier 131 in which the OIS driving magnet holders 141 and 142 are mounted.

Referring to FIG. 5, the mounting support portion 1311 of the carrier 131 includes an upright portion 131a and a bottom portion 131b perpendicular to each other, the upright portion 131a may be formed to face the first magnet accommodation portion 1410 of the first OIS driving magnet holder 141, and the bottom portion 131b may be formed to face a bottom surface of the first OIS driving magnet 1532. In this case, the side surface OIS yoke 1341 may be mounted on the upright portion 131a of the mounting support portion 1311, and the lower surface OIS yoke 1351 may be mounted on the bottom portion 131b of the mounting support portion 1311. Therefore, the side surface OIS yoke 1341 may be arranged to face the first OIS driving magnet 1532 in a direction perpendicular to the optical axis, and the lower surface OIS yoke 1351 may be arranged to face the first OIS driving magnet 1532 in a direction parallel to the optical axis.

The first OIS driving magnet 1532 may be mounted on the first magnet accommodation portion 1410 of the first OIS driving magnet holder 141 and arranged in the mounting support portion 1311 of the carrier 131. Therefore, the side surface OIS yoke 1341 mounted on the upright portion 131a of the mounting support portion 1311 faces the first OIS driving magnet 1532 with the first magnet accommodation portion 1410 interposed therebetween.

The side surface OIS yoke 1341 and the lower surface OIS yoke 1351 formed in this way may serve to pull the first OIS driving magnet 1532 toward the mounting support portion 1311 of the carrier 131 in the direction perpendicular to the optical axis and in the direction parallel to the optical axis. The first OIS driving magnet holder 141 on which the first OIS driving magnet 1532 is mounted may be supported at the rolling portions 1411 and 1412 (see FIG. 4) by the mounting support portion 1311 of the carrier 131 with the rolling member interposed therebetween. Due to attractive force acting between the first OIS driving magnet 1532 and the side surface and lower surface OIS yokes 1341 and 1351, the first OIS driving magnet holder 141 can be closely fixed more firmly to the bottom surface of the carrier 131 or the bottom portion 131b of the mounting support portion 1311 in an oblique direction (arrow direction in the drawing).

In addition, the side surface OIS yoke 1341 and the lower surface OIS yoke 1351 act together with the first coupling arm 1415 (see FIG. 4) formed on the first OIS driving magnet holder 141 to enable the lens holder 152 and the support frame 151 to be stably supported between the first OIS driving magnet holder 141 and the carrier 131. That is, when the side surface OIS yoke 1341 and the lower surface OIS yoke 1351 pull the first OIS driving magnet holder 141 downward, the first coupling arm 1415 can press the lens holder 152 and the support frame 151 from above and cause the lens holder and the support frame to closely contact the carrier 131 downward in the optical axis direction.

Although not separately shown in the drawings, similarly, the mounting support portion 1312 of the carrier 131 in which the second OIS driving magnet holder 142 is mounted may also be formed with an upright portion 131a facing the second magnet accommodation portion 1420 of the second OIS driving magnet holder 142 and a bottom portion 131b facing the bottom surface of the second OIS driving magnet 1552. In this case, the side surface OIS yoke 1341 may be mounted on the upright portion 131a of the mounting support portion 1312 and face the second OIS driving magnet 1552 in a direction perpendicular to the optical axis, and the lower surface OIS yoke 1351 may be mounted on the bottom portion 131b of the mounting support portion 1312 and face the second OIS driving magnet 1552 in a direction parallel to the optical axis.

In the meantime, although the side surface OIS yoke 1341 and the lower surface OIS yoke 1351 can be simultaneously applied to the mounting support portions 1311 and 1312 of the carrier 131, as described above, as another example, only one of the side surface OIS yoke 1341 and the lower surface OIS yoke 1351 may be applied, which also falls within the scope of the present disclosure. That is, the side surface OIS yokes 1341 may be arranged on the upright portions 131a of the mounting support portions 1311 and 1312 of the carrier 131 and the lower surface OIS yokes may be omitted, and to the contrary, the lower surface OIS yokes 1351 may be arranged on the bottom portions 131b of the mounting support portions 1311 and 1312 of the carrier 131 and the side surface OIS yokes may be omitted.

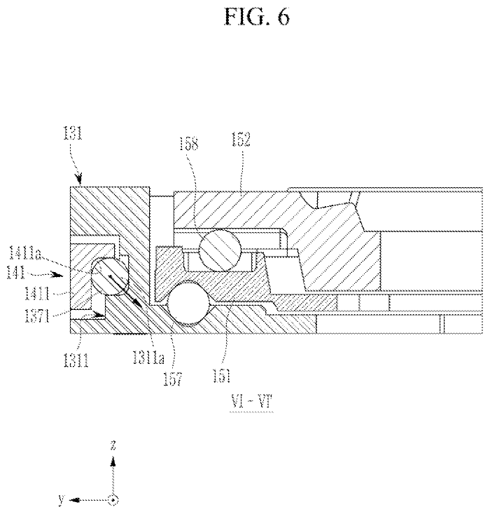

FIG. 6 is a partial cross-sectional view taken along a line VI-VI′ of FIG. 3.

In the lens driving apparatus 120 according to the present embodiment, the first OIS driving magnet holder 141 may be supported by the mounting support portion 1311 of the carrier 131 with the rolling members 1371 and 1372 interposed therebetween. As described above, the first OIS driving magnet holder 141 has the front end rolling portion 1411 and the rear end rolling portion 1412 extending forward and rearward in the longitudinal direction of the first magnet accommodation portion 1410, respectively, and the rolling members 1371 and 1372 may be arranged between the rolling portions 1411 and 1412 and the guide recesses of the mounting support portion 1311, respectively.

Referring to FIG. 6, the guide recess of the front end rolling portion 1411 and the guide recess of the mounting support portion 1311 may be formed such that respective valleys 1411a and 1311a thereof face each other in an oblique direction with respect to the optical axis direction. That is, the guide recess of the front end rolling portion 1411 and the guide recess of the mounting support portion 1311 may have valleys 1411a and 1311a each having an inwardly concave corner, respectively. The rolling member 1371 may contact a pair of inner surfaces located on both sides of the valley 1411a in the guide recess of the front end rolling portion 1411, respectively. In addition, the rolling member 1371 may also contact a pair of inner surfaces located on both sides of the valley 1311a in the guide recess of the mounting support portion 1311, respectively. Therefore, the rolling member 1371 comes into contact with a side surface and an upper surface in the guide recess of the front end rolling portion 1411, and comes into contact with a side surface and a lower surface in the guide recess of the mounting support portion 1311. Each of the valleys 1411a and 1311a may be formed round.

As described above with reference to FIG. 5, the first OIS driving magnet holder 141 may be attracted inwardly and downwardly in the oblique direction (arrow direction in the drawing) with respect to the optical axis direction by the side surface and lower surface OIS yokes 1341 and 1351. At this time, the rolling member 1371 interposed and supported between the OIS driving magnet holder 141 and the mounting support portion 1311 of the carrier 131 can be stably supported in the oblique direction with respect to the bottom surface of the carrier 131 between the guide recesses of the front end rolling portions 1411 and 1421 and the guide recess of the mounting support portion 1311 of the carrier 131.

Although not separately shown in the drawings, similarly, also for the second OIS driving magnet holder 142, the guide recess of the front end rolling portion 1421 and the guide recess of the mounting support portion 1312 may be formed such that respective valleys thereof face each other in an oblique direction with respect to the optical axis direction.

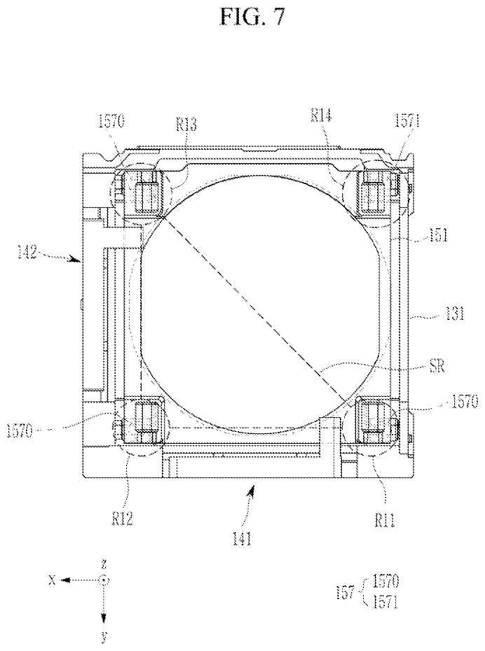

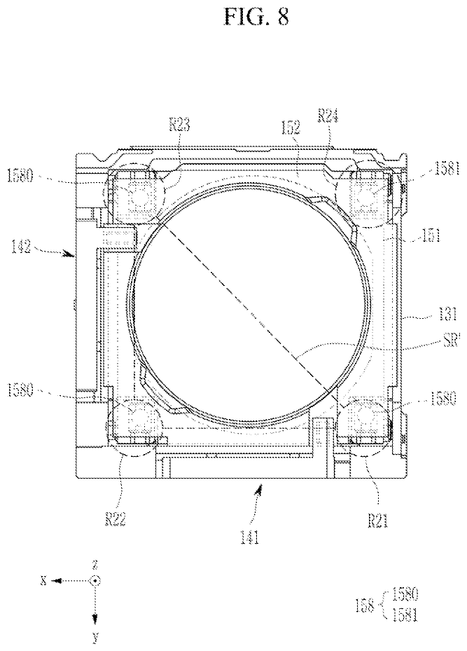

FIGS. 7 and 8 are plan views showing examples of the lens driving apparatus shown in FIG. 3, in which FIG. 7 shows the carrier and the support frame together with the OIS driving magnet holder, and FIG. 8 shows the carrier, the support frame and the lens holder together with the OIS driving magnet holder.

Referring to FIGS. 7 and 8, in the present embodiment, the lens holder 152, the support frame 151, and the carrier 131 may each have a frame structure having four corners. The carrier 131 and the support frame 151 may be formed with rolling parts R11, R12, R13, and R14 including guide recesses and the rolling members 157 accommodated in the guide recesses, in the four corner areas, respectively, on surfaces facing each other in the optical axis direction. In addition, the lens holder 152 and the support frame 151 may be formed with rolling parts R21, R22, R23, and R24 including guide recesses and the rolling members 158 accommodated in the guide recesses, in the four corner areas, respectively, on surfaces facing each other in the optical axis direction. The rolling parts R11, R12, R13, and R14 positioned between the carrier 131 and the support frame 151 and the rolling parts R21, R22, R23, and R24 positioned between the lens holder 152 and the support frame 151 may be approximately overlapped in the optical axis direction.

Referring to FIG. 7, among the rolling members 157 interposed between the carrier 131 and the support frame 151, the rolling members 1570 arranged in the rolling parts R11, R12, and R13 in the three corner areas may move together in contact with the carrier 131 and the support frame 151 to form a support area SR. That is, the rolling members 1570 in the support area SR may simultaneously contact and support the carrier 131 and the support frame 151 in the optical axis direction. In this case, the interval between the carrier 131 and the support frame 151 may be maintained by the rolling members 1570 positioned in the support area SR. The remaining one rolling member 1571 arranged outside the support area SR may be formed to have a diameter smaller than those of the rolling members 1570 so as not to contact the carrier 131 and the support frame 151 at the same time. Therefore, the support area SR may become a three-point support area.

Referring to FIG. 8, among the rolling members 158 interposed between the lens holder 152 and the support frame 151, the rolling members 1580 arranged in the rolling parts R21, R22, and R23 in the three corner areas may move together in contact with the lens holder 152 and the support frame 151 to form a support area SR′. That is, the rolling members 1580 in the support area SR′ may simultaneously contact and support the lens holder 152 and the support frame 151 in the optical axis direction. In this case, the interval between the lens holder 152 and the support frame 151 may be maintained by the rolling members 1580 positioned in the support area SR′. The remaining one rolling member 1581 arranged outside the support area SR′ may be formed to have a diameter smaller than those of the rolling members 1580 so as not to contact the lens holder 152 and the support frame 151 at the same time. Therefore, the support area SR′ may become a three-point support area.

In the present embodiment, the OIS driving magnet holders 141 and 142 may be arranged at edges of the carrier 131 corresponding to the support areas SR and SR′. That is, the support areas SR and SR′ may be each set to have an approximately triangular plane having two mutually perpendicular sides corresponding to two adjacent edges among the four edges of the carrier 131, and the OIS driving magnet holders 141 and 142 may be mounted on the two edges. In this case, the coupling arms 1415 and 1425 of the OIS driving magnet holders 141 and 142 may be arranged to span the two mutually perpendicular sides of the support areas SR and SR′.

In addition, the mounting support portions 1311 and 1312 in which the OIS driving magnet holders 141 and 142 are mounted may be arranged at the edges of the carrier 131, and the side surface OIS yoke 1341 and the lower surface OIS yoke 1351 may be arranged in the mounting support portions 1311 and 1312. Therefore, the side surface OIS yoke 1341 and the lower surface OIS yoke 1351 may be positioned within the three-point support areas SR and SR′.

As such, the OIS driving magnet holders 141 and 142 are arranged in the support areas SR and SR′ of the carrier 131, the support frame 151, and the lens holder 152, so that the OIS driving magnet holders 141 and 142 can be stably driven without shaking even if they are slide-driven within the mounting support portions 1311 and 1312 of the carrier 131. That is, since the lens holder 152, the support frame 151 and the carrier 131 are three-point supported and come into close contact with each other in the support areas SR and SR′, the OIS driving magnet holders 141 and 142 can be maintained firmly on the lens holder 152, the support frame 151, and the carrier 131 by the coupling arms 1415 and 1425 arranged to span the support areas SR and SR′.

In the above, the embodiment in which the rolling parts having the rolling members interposed in each of the four corner areas between the lens holder 152 and the support frame 151 or between the support frame 151 and the carrier 131 are provided has been shown and described. However, the rolling part positioned outside the support areas SR and SR′ may be omitted, which also falls within the scope of the present disclosure.

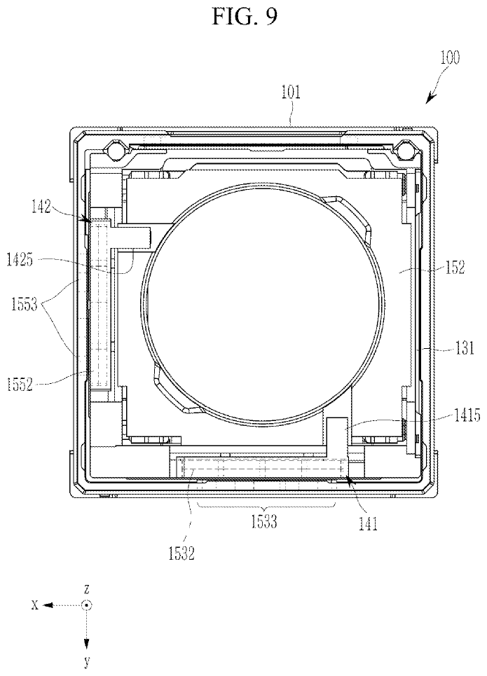

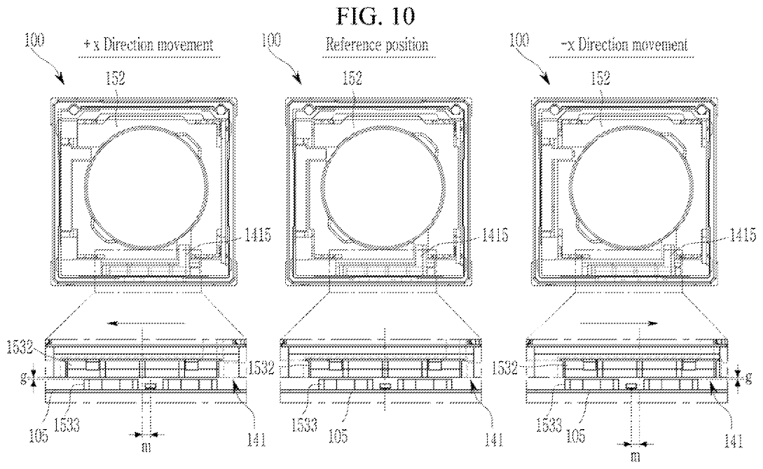

FIG. 9 is a plan view showing an example of the lens driving apparatus of the camera module shown in FIG. 1, and FIG. 10 is a plan view showing an example of an operation state of the lens driving apparatus of the camera module shown in FIG. 1.

Referring to FIG. 9, the camera module 100 according to the present embodiment may include the first OIS driving part 153 for OIS driving in the first direction (x-axis direction in the drawing) and the second OIS driving part 155 for OIS driving in the second direction (y-axis direction in the drawing). In this case, the first OIS driving part 153 and the second OIS driving part 155 may be arranged to correspond to two adjacent edges of the carrier 131, respectively.

The first OIS driving part 153 may include the first OIS driving magnet 1532 mounted on the first OIS driving magnet holder 141 and the first OIS driving coil 1533 mounted on the housing 101 so as to face the first OIS driving magnet. The second OIS driving part 155 may include the second OIS driving magnet 1552 mounted on the second OIS driving magnet holder 142 and the second OIS driving coil 1553 mounted on the housing 101 so as to face the second OIS driving magnet. In this case, the first OIS driving magnet 1532 and the first OIS driving coil 1533 may face each other in the second direction and the second OIS driving magnet 1552 and the second OIS driving coil 1553 may face each other in the first direction, in which the first and second directions may be perpendicular to each other.

When an electrical signal is applied to the first OIS driving coil 1533, the first OIS driving coil and the first OIS driving magnet 1532 corresponding thereto may act electromagnetically on each other to drive the first OIS driving magnet holder 141 in the first direction. At this time, the lens holder 152 coupled to the first OIS driving magnet holder 141 through the coupling arm 1415 may move in the first direction together with the driving of the first OIS driving magnet holder 141.

When an electrical signal is applied to the second OIS driving coil 1553, the second OIS driving coil and the second OIS driving magnet 1552 corresponding thereto may act electromagnetically on each other to drive the second OIS driving magnet holder 142 in the second direction. At this time, the lens holder 152 coupled to the second OIS driving magnet holder 142 through the coupling arm 1425 may move in the second direction together with the driving of the second OIS driving magnet holder 142.

Therefore, the first OIS driving magnet 1532 may be driven in a direction perpendicular to the direction facing the first OIS driving coil 1533, and the second OIS driving magnet 1552 may be driven in a direction perpendicular to the direction facing the second OIS driving coil 1553.

Referring to FIG. 10, when no electrical signal is applied to the first OIS driving coil 1533, the centers of the first OIS driving magnet 1532 and the first OIS driving coil 1533 may be aligned with each other (refer to “reference position” in FIG. 10). When an electrical signal is applied to the first OIS driving coil 1533, a driving force may be generated between the first OIS driving magnet 1532 and the first OIS driving coil 1533 by an electromagnetic interaction. Accordingly, the first OIS driving magnet holder 141 may be moved by a distance (m) set forward or backward (refer to “+x direction movement” and “−x direction movement” in FIG. 10) in the first direction (x-axis direction in the drawing), and the lens holder 152 may be moved along with this movement.

Even when the first OIS driving magnet holder 141 is driven in the first direction as described above, the first OIS driving magnet holder is slide-driven while firmly mounted in the mounting support portion 1311 of the carrier 131, so that an air gap (g) between the first OIS driving magnet 1532 and the first OIS driving coil 1533 can be maintained uniformly. That is, the air gap (g) with the first OIS driving coil 1533 may not change according to movement of the first OIS driving magnet 1532.

Similarly, even when the second OIS driving magnet holder 142 is driven in the second direction, the second OIS driving magnet holder is slide-driven while firmly mounted in the mounting support portion 1312 of the carrier 131, so that an air gap (g) between the second OIS driving magnet 1552 and the second OIS driving coil 1553 can be maintained uniformly.

Even when the first OIS driving magnet holder 141 is driven in the first direction as described above, the second OIS driving magnet holder is slide-driven while firmly mounted in the mounting support portion 1312 of the carrier 131, so that an air gap (g) between the second OIS driving magnet 1552 and the second OIS driving coil 1553 can be maintained uniformly. That is, the air gap (g) between the second OIS driving magnet 1552 and the second OIS driving coil 1553 may not change according to movement of the first OIS driving magnet 1532.

Similarly, even when the second OIS driving magnet holder 142 is driven in the second direction, the first OIS driving magnet holder is slide-driven while firmly mounted in the mounting support portion 1311 of the carrier 131, so that an air gap (g) between the first OIS driving magnet 1532 and the first OIS driving coil 1533 can be maintained uniformly. That is, the air gap (g) between the first OIS driving magnet 1532 and the first OIS driving coil 1533 may not change according to movement of the second OIS driving magnet 1552.

In the case of a comparative example in which the air gap between the driving magnet and the driving coil for implementing the optical image stabilization function is changed according to the OIS driving, differences may occur in driving force and current consumption value according to a difference between the minimum and maximum values of the air gap. However, since the air gap between the OIS driving magnet and the OIS driving coil in the lens driving apparatus according to the present embodiment can be maintained uniformly without changing according to the OIS driving, there is an advantage in reducing current consumption and securing driving force for OIS driving. In addition, as compared with the related art, size reduction of a magnetic field component and increase in driving efficiency can be unexpectedly realized.

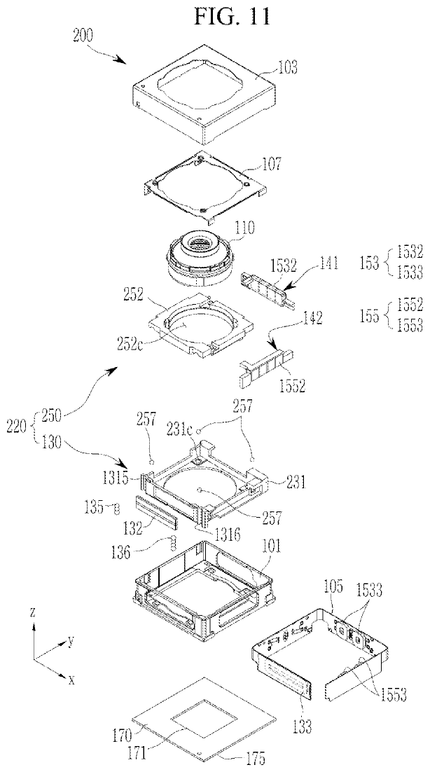

FIG. 11 is an exploded perspective view schematically showing a camera module according to another embodiment.

Referring to FIG. 11, a camera module 200 according to the present embodiment may have substantially the same configuration as the embodiments described with reference to FIGS. 1 to 10. However, in the present embodiment, the support frame may be omitted between a lens holder 252 and a carrier 231 of a lens driving apparatus 220. Hereinafter, configurations with differences will be described, and configurations not separately described may be configured similarly to the embodiments shown in FIGS. 1 to 10.

In the present embodiment, an OIS unit 250 may include a guide member configured to guide movement of the lens barrel 110 and an OIS driving part configured to generate a driving force for moving the guide member in a direction perpendicular to the optical axis direction.

The guide member may include a lens holder 252. The lens holder 252 may be accommodated in the carrier 231 and serve to guide movement of the lens barrel 110. The lens holder 252 has a central opening 252c into which the lens barrel 110 can be inserted, and the lens barrel 110 may be joined and fixed to the lens holder 252 through the central opening 252c. As an example, the lens holder 252 may have a frame shape having four corners.

A rolling member 257 configured to support the OIS unit 250 may be provided between the lens holder 252 and the carrier 231. The rolling member 257 serves to smooth movement of the lens holder 252 during an OIS driving process. In addition, the rolling member 257 also serves to maintain an interval between the carrier 231 and the lens holder 252. The rolling member 257 may be involved in movement of the OIS unit 250 in the first direction (x-axis direction) and the second direction (y-axis direction). The rolling member 257 may include a plurality of ball members arranged between the carrier 231 and the lens holder 252.

A surface of the carrier 231 facing the lens holder 252 in the optical axis direction may be formed with a guide recess portion 231c configured to accommodate the rolling member 257. The rolling member 257 may be accommodated in the guide recess portion 231c and may be sandwiched between the carrier 231 and the lens holder 252. In a state of being accommodated in the guide recess portion 231c, the rolling member 257 may be limited in movement in the optical axis direction, and may be moved in the first direction (x-axis direction) and the second direction (y-axis direction).

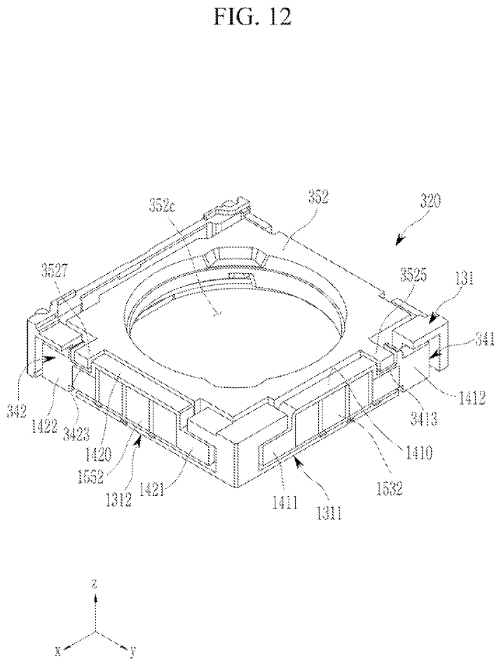

FIG. 12 is a perspective view showing a lens driving apparatus of a camera module according to still another embodiment.

Referring to FIG. 12, a lens driving apparatus 320 of a camera module according to the present embodiment may have substantially the same configuration as the embodiments described with reference to FIGS. 1 to 10. However, the present embodiment is different in that coupling arms 3525 and 3527 may be positioned in a lens holder 352 and coupling grooves 3413 and 3423 may be positioned in the OIS driving magnet holders 341 and 342. Hereinafter, configurations with differences will be described, and configurations not separately described may be configured similarly to the embodiments shown in FIGS. 1 to 10.

The lens holder 352 may include coupling arms 3525 and 3527 extending from an outer surface in a direction perpendicular to the outer surface, and the OIS driving magnet holders 341 and 342 may include coupling grooves 3413 and 3423 extending toward the central opening 352c. The coupling arms 3525 and 3527 of the lens holder 352 are inserted into the coupling grooves 3413 and 3423 of the OIS driving magnet holders 341 and 342, whereby the OIS driving magnet holders 341 and 342 may be coupled to the lens holder 352. That is, when the OIS driving magnet holders 341 and 342 are driven in the first or second direction perpendicular to the optical axis, the coupled lens holder 352 may be driven in the first or second direction together with the OIS driving magnet holders.

The coupling grooves 3413 and 3423 may be formed on upper surfaces of the OIS driving magnet holders 341 and 342 with respect to the optical axis direction. In addition, the coupling grooves 3413 and 3423 may be formed to penetrate in a width direction perpendicular to the longitudinal direction of the OIS driving magnet holders 341 and 342. The coupling grooves 3413 and 3423 may be arranged to extend in directions perpendicular to each other.

A rolling member may be arranged between the coupling arms 3525 and 3527 of the lens holder 352 and the coupling grooves 3413 and 3423 of the OIS driving magnet holders 341 and 342. The rolling member may have a ball shape.

The coupling arms 3525 and 3527 of the lens holder 352 may be arranged biased to one side relative to a center of one outer surface of the lens holder 352. Therefore, the coupling grooves 3413 and 3423 of the OIS driving magnet holders 341 and 342 may also be arranged biased to one side relative to the longitudinal centers of the OIS driving magnet holders 341 and 342 so that the coupling arms 3525 and 3427 are inserted.

The coupling grooves 3413 and 3423 may include a first coupling groove 3413 formed on the first OIS driving magnet holder 341 and a second coupling groove 3423 formed on the second OIS driving magnet holder 342. The coupling arms 3525 and 3527 may include a first coupling arm 3525 and a second coupling arm 3527 extending perpendicularly to each other from different outer surfaces of the lens holder 352. Accordingly, the first coupling arm 3525 may be inserted into the first coupling groove 3413, and the second coupling arm 3527 may be inserted into the second coupling groove 3423.

According to the lens driving apparatus according to the embodiments described herein, an air gap between the driving magnet and the driving coil can be maintained uniformly while performing an optical image stabilization function.

In addition, according to the camera module according to the embodiments described herein, the efficiency of the driving magnetic field part can be maximized by maintaining a uniform interval between the driving magnet and the driving coil for optical image stabilization.

This is advantageous in reducing current consumption and securing driving force for OIS driving, and as compared with the related art, size reduction of a magnetic field component and increase in driving efficiency can be unexpectedly realized.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving apparatus comprising:
a lens holder having a central opening so as to accommodate a lens;
a carrier configured to accommodate the lens holder;
an optical image stabilization (OIS) driving magnet holder having an OIS driving magnet mounted thereon, supported by the carrier, coupled to the lens holder, and configured to be driven in a direction perpendicular to an optical axis; and
an OIS driving coil facing the OIS driving magnet at an interval, in a direction perpendicular to the optical axis and to a direction in which the OIS driving magnet is driven.

2. The lens driving apparatus of claim 1,
further comprising an auto focus (AF) driving part comprising an AF driving magnet mounted on the carrier and an AF driving coil positioned to face the AF driving magnet, and configured to drive the lens holder in the optical axis direction.

3. The lens driving apparatus of claim 1, wherein
the OIS driving magnet holder comprises a first OIS driving magnet holder extending in a first direction perpendicular to the optical axis direction and a second OIS driving magnet holder extending in a second direction perpendicular to the optical axis direction and the first direction.

4. The lens driving apparatus of claim 1, wherein
the lens holder comprises a coupling groove extending in one direction, and
the OIS driving magnet holder comprises a coupling arm inserted in the coupling groove.

5. The lens driving apparatus of claim 4, wherein
the coupling groove extends from one outer surface of the lens holder toward the central opening.

6. The lens driving apparatus of claim 4, wherein
the coupling groove is formed on an upper surface of the lens holder with respect to the optical axis direction.

7. The lens driving apparatus of claim 4, wherein
the coupling arm extends in a direction perpendicular to one outer surface of the lens holder.

8. The lens driving apparatus of claim 4, wherein
a rolling member is arranged between the coupling arm and a bottom surface of the coupling groove.

9. The lens driving apparatus of claim 4, wherein
the coupling arm is arranged biased to one side relative to a longitudinal center of the OIS driving magnet holder.

10. The lens driving apparatus of claim 1, wherein
the OIS driving magnet holder comprises a coupling groove extending in one direction, and
the lens holder comprises a coupling arm inserted in the coupling groove.

11. The lens driving apparatus of claim 10, wherein
the coupling groove extends toward the central opening perpendicularly to one outer surface of the lens holder.

12. The lens driving apparatus of claim 10, wherein
the coupling arm extends in an outward direction perpendicularly to one outer surface of the lens holder.

13. The lens driving apparatus of claim 1, wherein
the carrier comprises a mounting support portion positioned outside one outer surface of the lens holder, and
the OIS driving magnet holder is mounted in the mounting support portion of the carrier.

14. The lens driving apparatus of claim 13, wherein
the OIS driving magnet holder further comprises:
a magnet accommodation portion extending in a direction parallel to the one outer surface of the lens holder, mounted in the mounting support portion, and configured to accommodate the OIS driving magnet, and
a rolling portion extending in a direction parallel to the one outer surface of the lens holder from the magnet accommodation portion.

15. The lens driving apparatus of claim 14, wherein
the rolling portion of the OIS driving magnet holder and the mounting support portion each include a guide recess, and
a rolling member is arranged between the guide recess of the rolling portion and the guide recess of the mounting support portion.

16. The lens driving apparatus of claim 15, wherein
a valley of the guide recess of the rolling portion and a valley of the guide recess of the mounting support portion are arranged to face each other in an oblique direction with respect to the optical axis direction.

17. The lens driving apparatus of claim 13, wherein
the mounting support portion further comprises:
at least one of a side surface OIS yoke facing the OIS driving magnet in a direction perpendicular to the optical axis direction, and a lower surface OIS yoke facing the OIS driving magnet in a direction parallel to the optical axis direction.

18. The lens driving apparatus of claim 1, wherein
the lens holder and the carrier each have at least four corner areas facing each other in the optical axis direction,
rolling parts with rolling members interposed in at least three corner areas among the four corner areas are positioned between the lens holder and the carrier,
the carrier comprises a support area comprising the rolling parts in three corner areas, among the rolling parts, in which the rolling members contact and support the lens holder and the carrier, and
the OIS driving magnet holder is arranged at an edge of the carrier corresponding to the support area.

19. The lens driving apparatus of claim 1, wherein
the lens holder and the carrier each have at least four corner areas facing each other in the optical axis direction,
rolling parts with rolling members interposed in at least three corner areas among the four corner areas are positioned between the lens holder and the carrier,
the carrier comprises a support area comprising the rolling parts in three corner areas, among the rolling parts, in which the rolling members contact and support the lens holder and the carrier, and
in the support area, the carrier further comprises:
at least one of a side surface OIS yoke facing the OIS driving magnet in a direction perpendicular to the optical axis direction, and a lower surface OIS yoke facing the OIS driving magnet in a direction parallel to the optical axis direction.

20. The lens driving apparatus of claim 1, wherein
an interval between the OIS driving magnet and the OIS driving coil is configured to be maintained uniformly when the OIS driving magnet holder is driven.

21. A portable electronic device comprising:
a camera module comprising the lens driving apparatus of claim 1, a lens barrel comprising the lens disposed in the central opening of the lens holder, an image sensor configured to convert light incident through the lens barrel into an electrical signal, and a housing configured to accommodate the lens barrel and the lens driving apparatus.

22. A camera module comprising:
a lens barrel comprising a lens;
a lens holder having a central opening in which the lens barrel is accommodated;
a carrier configured to accommodate the lens holder;
an optical image stabilization (OIS) driving magnet holder having an OIS driving magnet mounted thereon, supported by the carrier, coupled to the lens holder, and configured to be driven in a direction perpendicular to an optical axis; and
a housing configured to accommodate the carrier and comprising an OIS driving coil facing the OIS driving magnet at an interval, in a direction perpendicular to the optical axis and to a direction in which the OIS driving magnet is driven.

23. The camera module of claim 22, wherein
further comprising an auto focus (AF) driving part comprising an AF driving magnet mounted on the carrier and an AF driving coil positioned to face the AF driving magnet, and configured to drive the lens holder in the optical axis direction.

24. The camera module of claim 22, wherein
the OIS driving magnet holder comprises a first OIS driving magnet holder extending in a first direction perpendicular to the optical axis direction and a second OIS driving magnet holder extending in a second direction perpendicular to the optical axis direction and the first direction.

25. The camera module of claim 22, wherein
the lens holder comprises a coupling groove extending in one direction, and
the OIS driving magnet holder comprises a coupling arm inserted in the coupling groove.

26. The camera module of claim 22, wherein
the OIS driving magnet holder comprises a coupling groove extending in one direction, and
the lens holder comprises a coupling arm inserted in the coupling groove.

27. The camera module of claim 22, wherein
the carrier comprises a mounting support portion positioned outside one outer surface of the lens holder, and
the OIS driving magnet holder is arranged in the mounting support portion of the carrier.

28. The camera module of claim 27, wherein
the mounting support portion further comprises:
at least one of a side surface OIS yoke facing the OIS driving magnet in a direction perpendicular to the optical axis direction, and a lower surface OIS yoke facing the OIS driving magnet in a direction parallel to the optical axis direction.

29. The camera module of claim 22, wherein
the lens holder and the carrier each have at least four corner areas facing each other in the optical axis direction,
rolling parts with rolling members interposed in at least three corner areas among the four corner areas are positioned between the lens holder and the carrier,
the carrier comprises a support area comprising the rolling parts in three corner areas, among the rolling parts, in which the rolling members contact and support the lens holder and the carrier, and
the OIS driving magnet holder is arranged at an edge of the carrier corresponding to the support area.

30. The camera module of claim 22, wherein
the lens holder and the carrier each have at least four corner areas facing each other in the optical axis direction,
rolling parts with rolling members interposed in at least three corner areas among the four corner areas are positioned between the lens holder and the carrier,
the carrier comprises a support area comprising the rolling parts in three corner areas, among the rolling parts, in which the rolling members contact and support the lens holder and the carrier, and
in the support area, the carrier further comprises:
at least one of a side surface OIS yoke facing the OIS driving magnet in a direction perpendicular to the optical axis direction, and a lower surface OIS yoke facing the OIS driving magnet in a direction parallel to the optical axis direction.

31. A portable electronic device comprising:
the camera module of claim 22; and
an image sensor configured to convert light incident through the lens barrel into an electrical signal,
wherein the image sensor is disposed below the housing of the camera module.

32. A lens driving apparatus comprising:
a lens holder having a central opening to accommodate a lens;
a carrier configured to accommodate the lens holder; and
an optical image stabilization (OIS) driver configured to drive the lens holder in a first direction perpendicular to the optical axis,
wherein the OIS driver comprises:
an OIS driving magnet disposed on the carrier and spaced apart from an OIS driving coil in a second direction perpendicular to the optical axis by a gap, and
wherein the gap is maintained uniformly when the lens holder is driven in the first direction.

33. The lens driving apparatus of claim 32, wherein the OIS driving magnet is disposed in an OIS driving magnet holder supported by the carrier, coupled to the lens holder, and slide-driven in a third direction relative to the carrier by interaction between the OIS driving magnet and the OIS driving coil.

34. The lens driving apparatus of claim 33, wherein the second direction is the same as or different than the first direction, the third direction is the same as or different than the first direction, and the third direction is perpendicular to the second direction.

35. The lens driving apparatus of claim 33, wherein the lens holder comprises a coupling groove extending in one direction, and
the OIS driving magnet holder comprises a coupling arm inserted in the coupling groove.

36. The lens driving apparatus of claim 32, wherein the OIS driver further comprises a second OIS driving magnet disposed on the carrier and spaced apart from a second OIS driving coil in a third direction perpendicular to the second direction by a second gap, and
wherein the second gap is maintained uniformly when the lens holder is driven in the first direction.

37. The lens driving apparatus of claim 32, further comprising an auto focus (AF) driving magnet disposed on the carrier and configured to be driven in the optical axis direction.

38. A portable electronic device comprising:
a camera module comprising the lens driving apparatus of claim 32, a lens barrel comprising the lens disposed in the central opening of the lens holder, an image sensor configured to convert light incident through the lens barrel into an electrical signal, and a housing configured to accommodate the lens barrel and the lens driving apparatus.
